(19) United States
(12) Patent Application Publication
(10) Pub. No.: US 2018/0086429 A1
(43) Pub. Date: Mar. 29, 2018

(54) Airfoil-Shaped Body Having Composite Base Skin with Integral Hat-Shaped Spar

(71) Applicant: The Boeing Company, Chicago, IL (US)

(72) Inventors: Andrew Sheppard, Newport (AU); David Andrew Pook, East Malvern (AU); Adnan Raghdo, Sandringham (AU); Nigel Kai Hui Toh, Rowville (AU); Max Marley Osborne, Melbourne (AU)

(73) Assignee: The Boeing Company, Chicago, IL (US)

(21) Appl. No.: 15/278,144

(22) Filed: Sep. 28, 2016

(51) Int. Cl. B64C 3/18; B64C 3/26; B64C 9/00; B64C 3/58

(52) U.S. Cl. CPC B64C 3/185; B64C 3/26; B64C 2009/005; B64C 3/58; B64C 9/00

(57) ABSTRACT

An airfoil-shaped body (such as a wing or a flight control surface) comprising a base assembly made of composite material, which base assembly in turn comprises a base skin and one or more hat-shaped spars integrally formed with the base skin. The airfoil-shaped body further comprise a close-out skin that is attached to the hat-shaped spars using fasteners. The method for manufacturing such an airfoil-shaped body uses a resin infusion process.

### BACKGROUND

The technology disclosed herein generally relates to airfoil-shaped bodies for aircraft and, in particular, to wings and flight control surfaces for aircraft.

The movement of an aircraft in different directions may be controlled using flight control surfaces. For example, flight control surfaces may be used to rotate an aircraft to change pitch, roll, and yaw of the aircraft. Additionally, flight control surfaces also may be used to change the coefficient of lift of wings on an aircraft. A flight control surface may be, for example, without limitation, an aileron, an elevator, a rudder, a spoiler, a flap, a slat, an airbrake, an elevator trim, or some other suitable type of control surface.

For example, flaps are a type of high-lift device used to increase the lift of an aircraft wing at a given airspeed. Flaps are typically mounted on the wing trailing edges of a fixed-wing aircraft. These flaps are often used to reduce the stalling speed of an aircraft during phases of flight, such as, for example, without limitation, takeoff and landing. In particular, extending flaps increases the camber of the wing airfoil, which, in turn, increases the maximum lift coefficient. The camber is the difference between the top and bottom curves of the wing airfoil. The increase in the maximum lift coefficient allows the aircraft to generate a given amount of lift with a slower speed. In this manner, extending the flaps reduces the stalling speed of the aircraft.

The design of airfoil-shaped bodies such as wings and flight control surfaces must take into account multiple issues such as structural integrity, manufacturing cost, tooling simplicity, non-destructive inspection access, fitting integration, damage tolerance and repair options. It would be desirable to provide airfoil-shaped bodies having improvements that address one or more of these issues.

### SUMMARY

The subject matter disclosed in detail below is directed to airfoil-shaped bodies (such as wings and flight control surfaces) comprising a base assembly made of composite material, which base assembly in turn comprises a base skin and one or more hat-shaped spars integrally formed with the base skin. (As used herein, the term “composite material” means “fiber-reinforced plastic”, for example, carbon fiber-reinforced plastic.) The airfoil-shaped bodies further comprise a close-out skin that is attached to the hat-shaped spars using fasteners. The disclosed subject matter is also directed to methods for manufacturing such airfoil-shaped bodies using a resin infusion process. Airfoil-shaped bodies designed and manufactured in accordance with the embodiments disclosed herein provide improvements in one or more of the following: structural integrity, manufacturing cost, tooling simplicity, non-destructive inspection access, fitting integration, damage tolerance and repair options.

One aspect of the subject matter disclosed in detail below is an airfoil-shaped body comprising: a base skin made of composite material; a first hat-shaped spar made of composite material and comprising a forward flange and an aft flange integrally formed with the base skin, a top, a forward web that connects the forward flange to the top, and an aft web that connects the aft flange to the top; a close-out skin; and a first plurality of fasteners by which the close-out skin is attached to the top of the first hat-shaped spar. In accordance with some embodiments, the airfoil-shaped body further comprises: a second hat-shaped spar made of composite material and comprising a forward flange and an aft flange integrally formed with the base skin, a top, a forward web that connects the forward flange to the top, and an aft web that connects the aft flange to the top; a second plurality of fasteners by which the close-out skin is attached to the top of the second hat-shaped spar; a nose; and a third plurality of fasteners by which the nose is attached to the base skin.

At least one of the hat-shaped spars in the airfoil-shaped body described in the preceding paragraph may have one or more of the following features: (a) a profile of the hat-shaped spar varies in a spanwise direction; (b) a thickness of a web of the hat-shaped spar varies in a spanwise direction; (c) the top of the hat-shaped spar is not parallel to the base skin; and (d) a first base angle between a web of the hat-shaped spar and the base skin is different than of a second base angle between the web of the hat-shaped spar and the base skin.

Another aspect of the subject matter disclosed in detail below is an airfoil-shaped body comprising: a base skin made of composite material; a hat-shaped spar made of composite material and comprising a forward flange and an aft flange integrally formed with the base skin, a top, a forward web that connects the forward flange to one side of the top, and an aft web that connects the aft flange to another side of the top; a close-out skin; a first plurality of fasteners by which the close-out skin is attached to the top of the first hat-shaped spar; and a second plurality of fasteners by which a trailing portion of the close-out skin is attached to a trailing portion of the base skin to form a trailing edge of the airfoil-shaped body.

A further aspect of the subject matter disclosed in detail below is a method of manufacturing an airfoil-shaped body, comprising: (a) forming a base assembly made of composite material using a resin infusion process, the base assembly comprising a base skin and a hat-shaped spar having a forward flange and an aft flange integrally formed with the base skin, a top, a forward web that connects the forward flange to the top, and an aft web that connects the aft flange to the top; (b) forming a close-out skin; (c) fastening the close-out skin to the top of the hat-shaped spar; and (d) fastening a trailing portion of the base skin to a trailing portion of the close-out skin.

In accordance with some embodiments, step (a) of the method described in the preceding paragraph comprises: placing a first plurality of plies of fabric on a surface of a base tool having a concavity configured to shape the hat-shaped spar; placing a mandrel in the concavity on top of the first plurality of plies of fabric; placing two noodles and a second plurality of plies of fabric over the mandrel and adjacent portions of the first plurality of plies of fabric; placing a caul plate over the second plurality of plies of fabric; placing a vacuum bag over the caul plate; evacuating a space between the vacuum bag and the base tool; infusing resin into the first and second pluralities of plies of fabric; and curing the infused resin.

In accordance with other embodiments, step (a) of the method of manufacturing an airfoil-shaped body comprises: placing a multiplicity of braids on a surface of a base tool having a concavity configured to form the hat-shaped spar; placing a mandrel in the concavity on top of the multiplicity of braids in the concavity; placing two noodles and a multiplicity of tapes over the mandrel and adjacent portions of the multiplicity of braids; placing a caul plate over the multiplicity of tapes; placing a vacuum bag over the caul plate; evacuating a space between the vacuum bag and the base tool; infusing resin into the multiplicity of braids and multiplicity of tapes; and curing the infused resin.

Other aspects of airfoil-shaped bodies having hat-shaped spars and methods for manufacturing such airfoil-shaped bodies are disclosed below.

### BRIEF DESCRIPTION OF THE DRAWINGS

The features, functions and advantages discussed in the preceding section can be achieved independently in various embodiments or may be combined in yet other embodiments. Various embodiments will be hereinafter described with reference to drawings for the purpose of illustrating the above-described and other aspects.

FIG. 1 is a diagram representing a top view of an aircraft incorporating different types of flight control surfaces.

FIG. 2 is a diagram representing an end view of a base assembly comprising a base skin and a pair of hat-shaped spars integrally formed with the base skin and indicating various chordwise dimensional parameters.

FIG. 3 is a diagram representing an end view of unassembled components of a high-lift trailing edge flap in accordance with a first flap embodiment in which the base assembly has a first configuration.

FIG. 3A is a diagram representing an end view of the beam-shaped spar surrounded by the dashed ellipse 3A seen in FIG. 3, which beam-shaped spar has forward and aft flanges and a structural noodle co-infused with the base skin.

FIG. 4 is a diagram representing an end view of unassembled components of a high-lift trailing edge flap in accordance with a second flap embodiment in which the base assembly has a second configuration.

FIG. 5 is a diagram representing an end view of unassembled components of a high-lift trailing edge flap in accordance with a third flap embodiment in which the base assembly has a third configuration.

FIG. 6 is a diagram representing an end view of unassembled components of a high-lift trailing edge flap in accordance with a fourth flap embodiment in which the base assembly has a fourth configuration.

FIG. 6A is a diagram representing an end view of unassembled components of a forward portion of a high-lift trailing edge flap that has a variation from the structure of the fourth flap embodiment depicted in FIG. 6.

FIG. 7 is a diagram representing a sectional view of partially assembled components of a flight control surface (e.g., an aileron, an elevator or a rudder) in accordance with an embodiment in which the base assembly has a fifth configuration.

FIG. 8 is a diagram representing a sectional view of partially assembled components of a flight control surface (e.g., an aileron, an elevator or a rudder) in accordance with an embodiment in which the base assembly has a sixth configuration.

FIG. 9 is a diagram representing a sectional view of partially assembled components of a wing spoiler in accordance with an embodiment in which the base assembly has a configuration similar to the sixth configuration.

FIG. 10 is a diagram showing a tooling concept for manufacturing the base assembly depicted in FIG. 6 using a resin infusion process.

FIG. 11 is a diagram showing a tooling concept for manufacturing a base assembly having a structure similar to the base assembly depicted in FIG. 7 using a resin infusion process.

FIG. 12 is a flowchart identifying some steps of a method for manufacturing an airfoil-shaped body having a hat-shaped spar with flanges co-infused with a base skin.

FIG. 13 is a block diagram identifying some components of a resin infusion system that can be used to manufacture base assemblies made of composite material.

FIG. 14 is a diagram representing an exploded sectional view of unassembled components of a high-lift trailing edge flap of the type depicted in FIG. 4 having support fittings (viewed from one side) arranged in a first fitting configuration.

FIG. 15 is a diagram representing an exploded sectional view of unassembled components of a high-lift trailing edge flap of the type depicted in FIG. 6 having support fittings (viewed from one side) arranged in a second fitting configuration.

FIG. 16 is a diagram representing an exploded sectional view of unassembled components of a flight control surface of the type depicted in FIG. 7 having support fittings (viewed from one side) arranged in a third fitting configuration.

Reference will hereinafter be made to the drawings in which similar elements in different drawings bear the same reference numerals.

### DETAILED DESCRIPTION

Illustrative embodiments of airfoil-shaped bodies comprising a composite base skin and one or more composite hat-shaped spars integrally formed with the base skin are described in some detail below. However, not all features of an actual implementation are described in this specification. A person skilled in the art will appreciate that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

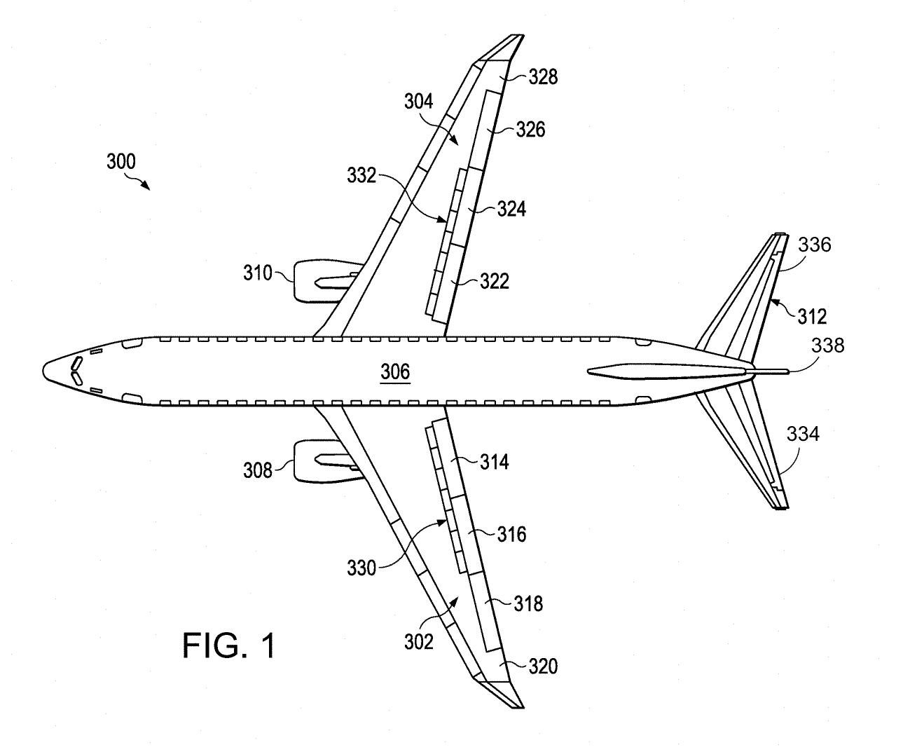

FIG. 1 is a diagram representing a top view of an aircraft 300 having different types of flight control surfaces. Aircraft 300 has wings 302 and 304 attached to a fuselage 306. Aircraft 300 includes a left wing-mounted engine 308, a right-wing-mounted engine 310, and a tail 312 comprising horizontal and vertical stabilizers. As depicted in this example, aircraft 300 also includes the following flight control surfaces: flaps 314 and 316 and aileron 318 associated with the trailing edge 320 of wing 302; flaps 322 and 324 and aileron 326 associated with the trailing edge 328 of wing 304; elevators 334 and 336 associated with the horizontal stabilizer; and a rudder 338 associated with the vertical stabilizer. Additionally, in the example depicted in FIG. 1, spoilers 330 are associated with wing 302 and spoilers 332 are associated with wing 304. In other examples, other control surfaces in addition to and/or in place of the ones shown in FIG. 1 may be associated with an aircraft.

In accordance with the embodiments disclosed in some detail hereinafter, one or more of the different types of flight control surfaces depicted in FIG. 1 may be comprise a composite base skin and one or more composite hat-shaped spars integrally formed with the base skin. However, the concepts disclosed herein are not limited in their application to flight control surfaces, but rather may also find application in the manufacture of wings and tails of an aircraft.

As used herein, the term “airfoil-shaped body” means a cambered structure comprising leading and trailing edges connected by top and bottom surfaces, the leading edge being the point at the front of the structure that has maximum curvature and the trailing edge being the point of maximum curvature at the rear of the structure. Camber is the asymmetry between the top and bottom surfaces. As used herein, the terms “forward” and “aft”, when used in conjunction to characterize a pair of elements of an airfoil-shaped body, indicate that one element of the pair (i.e., the “forward” element) is closer to the leading edge than is the other element of the pair (i.e., the “forward” element). Conversely, the aft element is closer to the trailing edge than is the forward element.

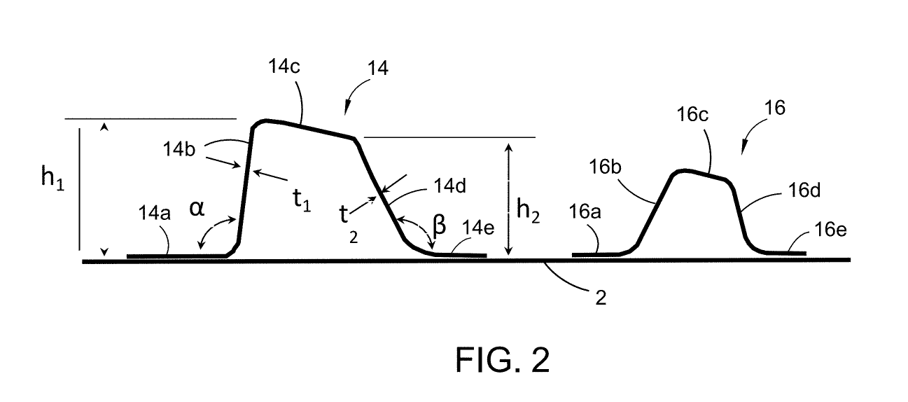

FIG. 2 is a diagram representing an end view of a base assembly comprising a base skin 2 made of composite material and a pair of hat-shaped spars 14 and 16 (also made of composite material) integrally formed with the base skin 2. As seen in FIG. 2, each of the hat-shaped spars 14 and 16 has an asymmetric profile. Each asymmetric profile may vary in size and shape in the spanwise direction, which variations are not shown in FIG. 2. The hat-shaped spar 14 comprises a forward flange 14a and an aft flange 14e integrally formed with the base skin 2, a top 14c, a forward web 14b that connects the forward flange 14a to the top 14c by way of respective radiused surfaces, and an aft web 14d that connects the aft flange 14e to the top 14c by way of respective radiused surfaces. In the example depicted in FIG. 2, the top 14c of hat-shaped spar 14 is not parallel to the underlying portion of the base skin 2 (which may not be planar). Similarly, the hat-shaped spar 16 comprises a forward flange 16a and an aft flange 16e integrally formed with the base skin 2, a top 16c, a forward web 16b that connects the forward flange 16a to the top 16c by way of respective radiused surfaces, and an aft web 16d that connects the aft flange 16e to the top 16c by way of respective radiused surfaces. In the example depicted in FIG. 2, the top 16c of hat-shaped spar 16 is not parallel to the underlying portion of the base skin 2.

The flanges, webs and tops depicted in FIG. 2 may be planar surfaces connected by radiused surfaces. For the sake of clarity, FIG. 2 shows gaps between the flanges and the base skin 2. However, it should be appreciated that in the airfoil-shaped bodies disclosed herein, there are no such gaps. On the contrary, the flanges (which are made of composite material) are integrally formed with the base skin 2 (which is also made of composite material). It should also be appreciated that the base assembly depicted in FIG. 2 may be arranged so that the base skin 2 forms either the top surface or bottom surface of the airfoil-shaped body.

FIG. 2 also indicates various chordwise dimensional parameters of the hat-shaped spar 14. The hat-shaped spar 16 has similar dimensional parameters. In FIG. 2, h₁ indicates the forward height of hat-shaped spar 14; h₂ indicates the aft height of hat-shaped spar 14; t₁ indicates the thickness of forward web 14b; t₂ indicates the thickness of aft web 14d; α indicates the forward base angle between forward flange 14a and forward web 14b; and β indicates the aft base angle between aft flange 14e and aft web 14d. The heights are measured relative to the closest surface of the base skin 2.

In the remaining disclosure, any reference to a “hat-shaped spar” means a structure comprising forward and aft flanges, a top, and forward and aft webs that respectively connect the forward and aft flanges to the top. In any given plane perpendicular to the spanwise direction, the flanges may be co-planar or not; the top may be parallel to the base skin or not (i.e., the heights h₁ and h₂ may be equal or not); the base angles α and β may be equal or unequal; the thicknesses t₁ and t₂ may be equal or unequal. In addition, all of these geometric relationships and dimensions may vary in the spanwise direction.

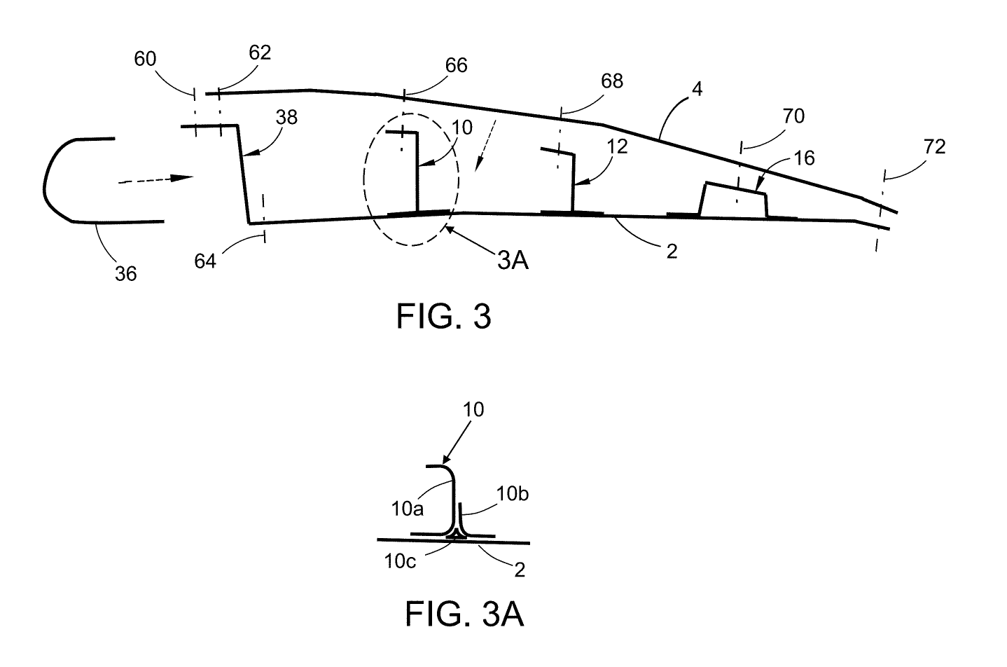

High-lift trailing edge flap in accordance with various embodiments will now be described with reference to FIGS. 3 through 6. Each of these flaps comprises a base assembly made of composite material. However, the respective base assemblies have different configurations as described in some detail below.

FIG. 3 represents an end view of unassembled components of a high-lift trailing edge flap in accordance with a first flap embodiment in which the base assembly has a first configuration. The base assembly comprises a base skin 2 made of laminated composite material, with a forward portion of the base skin being formed into an forward inverted L-shaped spar 38. The base assembly further comprises a forward beam-shaped spar 10, an intermediate beam-shaped spar 12 and an aft hat-shaped spar 16, each made of laminated composite material and each having flanges integrally formed (i.e., co-infused) with base skin 2.

The flap components depicted in FIG. 3 further include a close-out skin 4 fabricated from laminated composite material or stamped thermoplastic material. In alternative embodiments, the close-out skin may comprise pre-preg composite material panelized with honeycomb composite material. As used herein, “pre-preg” means a woven or braided fabric or cloth-like tape material, e.g., fiberglass or carbon fibers, that has been impregnated with an uncured or partially cured resin, which is flexible enough to be formed into a desired shape, then “cured,” e.g., by the application of heat in an oven or an autoclave, to harden the resin into a strong, rigid, fiber-reinforced structure.

In the embodiment depicted in FIG. 3, the close-out skin 4 will be attached to the base assembly by five pluralities of fasteners. Each plurality of fasteners may be arranged as a respective row of fasteners spaced apart at intervals in the spanwise direction (i.e., into the page as seen in FIG. 3). The convention has been adopted in the drawings that dash-dot lines (as used herein, the term “dash-dot line” means a linear arrangement of one or more dots and one or more dashes) represent respective pluralities (i.e., rows) of spaced fasteners. Consequently, the reference numbering convention is adopted in this detailed description that each short dash-dot line labeled with the reference number X symbolizes a corresponding plurality of fasteners X.

Applying the foregoing conventions, FIG. 3 shows that the close-out skin 4 will be attached to the top of the forward inverted L-shaped spar 38 by a plurality of fasteners 62, to the top of the forward beam-shaped spar 10 by a plurality of fasteners 66, to the top of the intermediate beam-shaped spar 12 by a plurality of fasteners 68, and to the top of the aft hat-shaped spar 16 by a plurality of fasteners 70. In addition, the trailing edge of the close-out skin 4 will be attached to the trailing edge of the base skin 2 by a plurality of fasteners 72 to form the trailing edge of the flap.

The flap components depicted in FIG. 3 further include a nose 36 fabricated from laminated composite material or stamped thermoplastic material. One portion of nose 36 will be attached to the top of the forward inverted L-shaped spar 38 by a plurality of fasteners 60, while another portion of nose 36 will be attached to the base skin 2 by a plurality of fasteners 64.

FIG. 3A is a diagram representing an end view of the forward beam-shaped spar 10 seen in FIG. 3. The forward beam-shaped spar 10 comprises a first composite laminate 10a that includes a forward flange, a top, and a first web connected to the forward flange and to the top by respective radiused area; a second composite laminate 10b that includes an aft flange and a second web connected by a radiused area, and a structural noodle 10c (a.k.a. “radius filler”) made of composite material or partially cured adhesive that fills the gap between the radiused areas at the forward and aft flanges in order to provide additional structural reinforcement to that region. For the purpose of illustration, these parts of the forward beam-shaped spar 10 are shown separated by gaps. However, in actuality the webs of the composite laminates 10a and 10b are co-infused with each other with no gap therebetween, while the flanges of the composite laminates 10a and 10b and the noodle 10c are co-infused with the base skin 2 with no gap therebetween. The intermediate beam-shaped spar 12 seen in FIG. 3 is fabricated in a similar fashion.

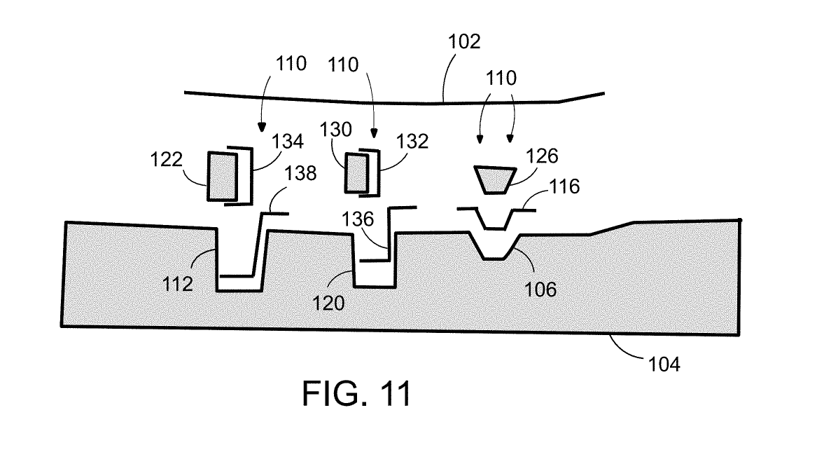

In accordance with alternative embodiments, each beam-shaped spar may comprise a first composite laminate that includes a forward flange, a top, and a first web connected to the forward flange and to the top by respective radiused areas; a second composite laminate that includes an aft flange, a top, and a second web connected to the aft flange and to the top by respective radiused areas, and a structural noodle 10c (a.k.a. “radius filler”) made of composite material that fills the gap between the radiused areas at the forward and aft flanges. In this case, the webs of the first and second composite laminates are fused together, as are the tops. A tooling concept for the fabrication of a base assembly having beam-shaped spars in accordance with this alternative construction will be described later with reference to FIG. 11.

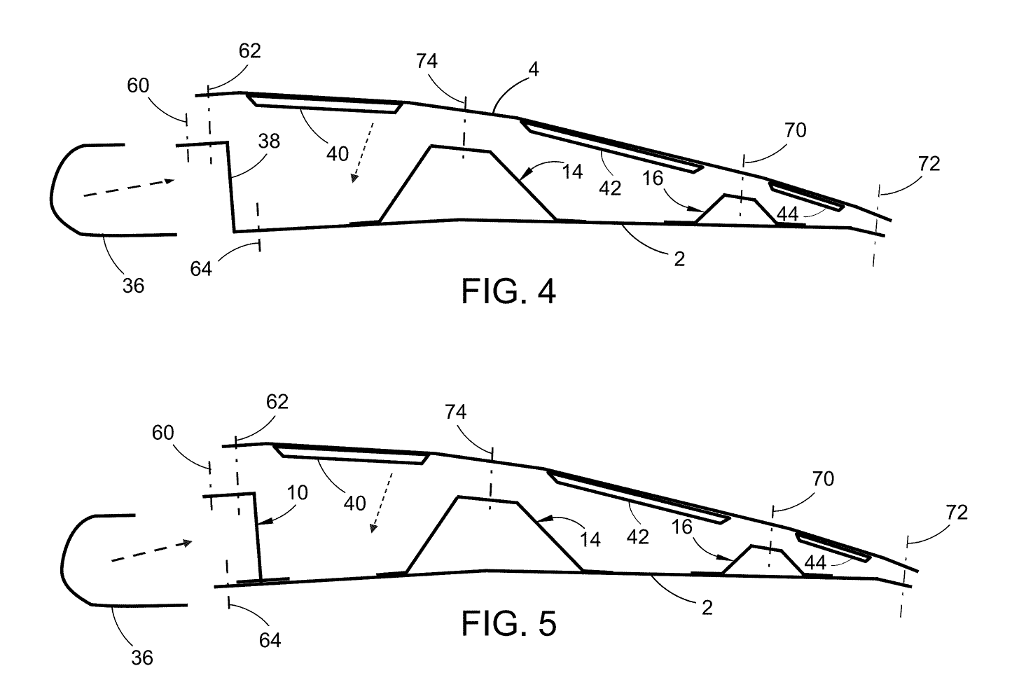

FIG. 4 is a diagram representing an end view of unassembled components of a high-lift trailing edge flap in accordance with a second flap embodiment in which the base assembly has a second configuration. The base assembly comprises a base skin 2 made of laminated composite material, with a forward portion of the base skin being formed into an forward inverted L-shaped spar 38. The base assembly further comprises an intermediate hat-shaped spar 14 and an aft hat-shaped spar 16, each made of laminated composite material and each having flanges integrally formed (i.e., co-infused) with base skin 2.

The flap components depicted in FIG. 4 further include a close-out skin 4 comprising pre-preg composite material with honeycomb panels 40, 42 and 44 made of composite material attached thereto. In the embodiment depicted in FIG. 4, the close-out skin 4 will be attached to the base assembly by four pluralities of fasteners. Applying the previously adopted conventions, FIG. 4 shows that the close-out skin 4 will be attached to the top of the forward inverted L-shaped spar 38 by a plurality of fasteners 62, to the top of the intermediate hat-shaped spar 14 by a plurality of fasteners 74, and to the top of the aft hat-shaped spar 16 by a plurality of fasteners 70. In addition, the trailing edge of the close-out skin 4 will be attached to the trailing edge of the base skin 2 by a plurality of fasteners 72 to form the trailing edge of the flap. In the assembled state, honeycomb panel 40 is disposed between the top of the forward inverted L-shaped spar 38 and the top of the hat-shaped spar 14; honeycomb panel 42 is disposed between the tops of the hat-shaped spars 14 and 16; and honeycomb panel 44 is disposed between the top of the hat-shaped spar 16 and the trailing edge of the flap.

The flap components depicted in FIG. 4 further include a nose 36 fabricated from laminated composite material or stamped thermoplastic material. One portion of nose 36 will be attached to the top of the forward inverted L-shaped spar 38 by a plurality of fasteners 60, while another portion of nose 36 will be attached to the base skin 2 by a plurality of fasteners 64.

FIG. 5 is a diagram representing an end view of unassembled components of a high-lift trailing edge flap in accordance with a third flap embodiment in which the base assembly has a third configuration. The primary difference between the second and third configurations of the base assembly is that the third configuration incorporates a forward beam-shaped spar 10 of the type shown in FIG. 3 co-infused with the base skin 2, instead of an forward inverted L-shaped spar 38 formed as part of the base skin 2.

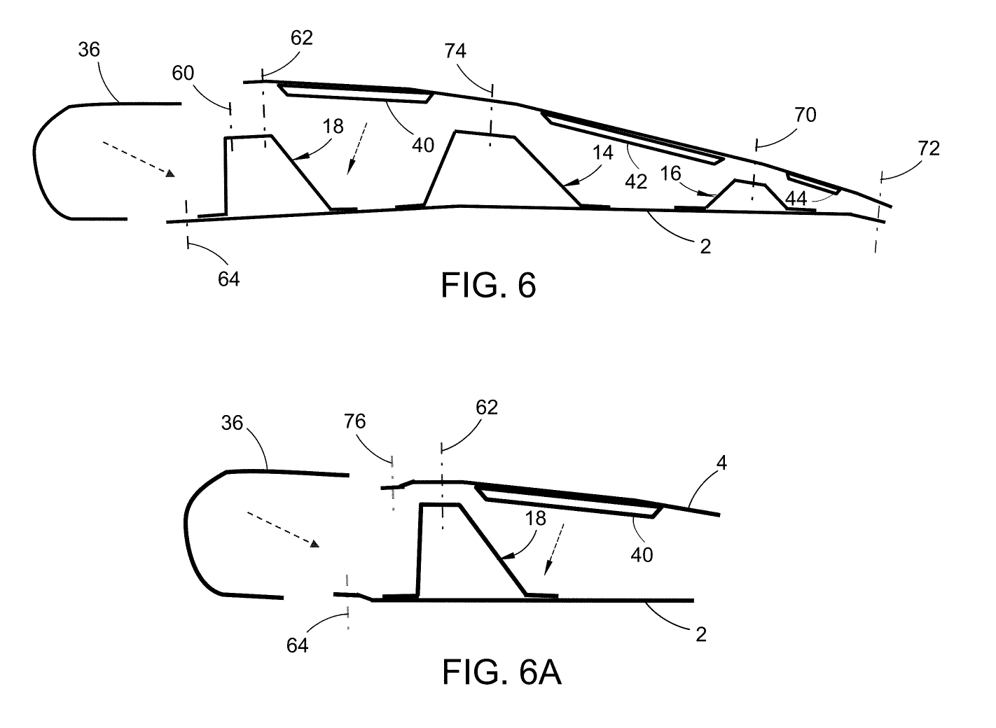

FIG. 6 is a diagram representing an end view of unassembled components of a high-lift trailing edge flap in accordance with a fourth flap embodiment in which the base assembly has a fourth configuration. The primary difference between the third and fourth configurations of the base assembly is that the fourth configuration incorporates a forward hat-shaped spar 18 co-infused with the base skin 2 (as shown in FIG. 6), instead of a forward beam-shaped spar 10 of the type shown in FIG. 5.

FIG. 6A is a diagram representing an end view of unassembled components of a forward portion of a high-lift trailing edge flap that has a variation from the structure of the fourth flap embodiment depicted in FIG. 6. The variation is that the close-out skin 4 is extended forward beyond the top of the forward hat-shaped spar 18 and the nose 36 will be attached to that forward extension of close-out skin 4 by a plurality of fasteners 76, instead of being attached to the top of the forward hat-shaped spar 18 as seen in FIG. 6.

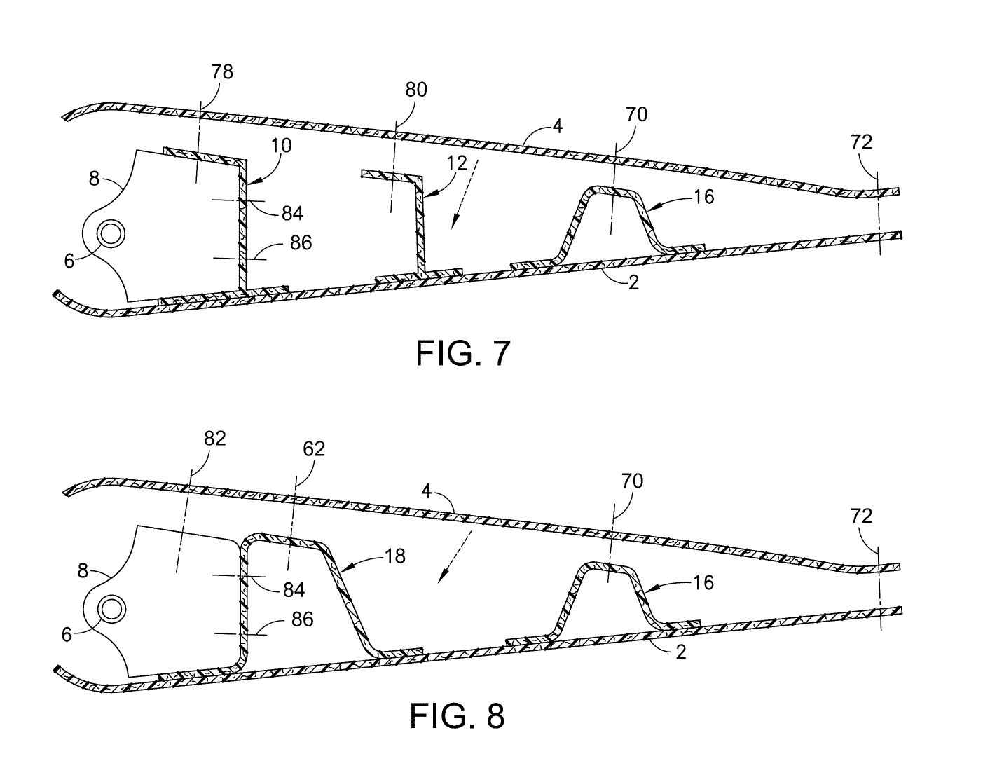

Flight control surfaces in accordance with two embodiments, for use as an aileron, an elevator or a rudder, will now be described with reference to FIGS. 7 and 8. Each of these flight control surfaces comprises a base assembly made of composite material. However, the respective base assemblies have different configurations as described in some detail below.

FIG. 7 is a diagram representing a sectional view of partially assembled components of a flight control surface (e.g., an aileron, an elevator or a rudder) in accordance with an embodiment in which the base assembly has a fifth configuration. The base assembly comprises a base skin 2 made of laminated composite material. The base assembly further comprises a forward beam-shaped spar 10, an intermediate beam-shaped spar 12 and an aft hat-shaped spar 16, each made of laminated composite material and each having flanges integrally formed (i.e., co-infused) with base skin 2. The web of the forward beam-shaped spar 10 is attached to hinge fitting 8 by a pair of fasteners 84 and 86. The hinge fitting 8 is attached to an axle 6 that can be rotated in response to activation of an actuator (not shown), thereby causing the flight control surface to rotate about the axis of hinge fitting 6.

The control surface components depicted in FIG. 7 further include a close-out skin 4 fabricated from laminated composite material or stamped thermoplastic material. In alternative embodiments, the close-out skin may comprise pre-preg composite material panelized with honeycomb composite material. In the embodiment depicted in FIG. 7, the close-out skin 4 will be attached to the base assembly by four pluralities of fasteners. Each plurality of fasteners may be arranged as a respective row of fasteners spaced apart at intervals in the spanwise direction. Applying the previously adopted conventions, FIG. 7 shows that the close-out skin 4 will be attached to the top of the forward beam-shaped spar 10 by a plurality of fasteners 78, to the top of the intermediate beam-shaped spar 12 by a plurality of fasteners 80, and to the top of the aft hat-shaped spar 16 by a plurality of fasteners 70. In addition, the trailing edge of the close-out skin 4 will be attached to the trailing edge of the base skin 2 by a plurality of fasteners 72 to form the trailing edge of the flight control surface.

FIG. 8 is a diagram representing a sectional view of partially assembled components of a flight control surface (e.g., an aileron, an elevator or a rudder) in accordance with an embodiment in which the base assembly has a sixth configuration. The base assembly comprises a base skin 2 made of laminated composite material. The base assembly further comprises a forward hat-shaped spar 18 and an aft hat-shaped spar 16, each made of laminated composite material and each having flanges integrally formed (i.e., co-infused) with base skin 2. The forward web of the forward hat-shaped spar 18 is attached to hinge fitting 8 by a pair of fasteners 84 and 86. The hinge fitting 8 is attached to an axle 6 that can be rotated in response to activation of an actuator (not shown).

The control surface components depicted in FIG. 8 further include a close-out skin 4 fabricated from laminated composite material or stamped thermoplastic material. In alternative embodiments, the close-out skin may comprise pre-preg composite material panelized with honeycomb composite material. In the embodiment depicted in FIG. 8, the close-out skin 4 will be attached to the base assembly by three pluralities of fasteners. More specifically, FIG. 8 shows that the close-out skin 4 will be attached to the top of the forward hat-shaped spar 18 by a plurality of fasteners 62 and to the top of the aft hat-shaped spar 16 by a plurality of fasteners 70. In addition, the trailing edge of the close-out skin 4 will be attached to the trailing edge of the base skin 2 by a plurality of fasteners 72 to form the trailing edge of the flight control surface.

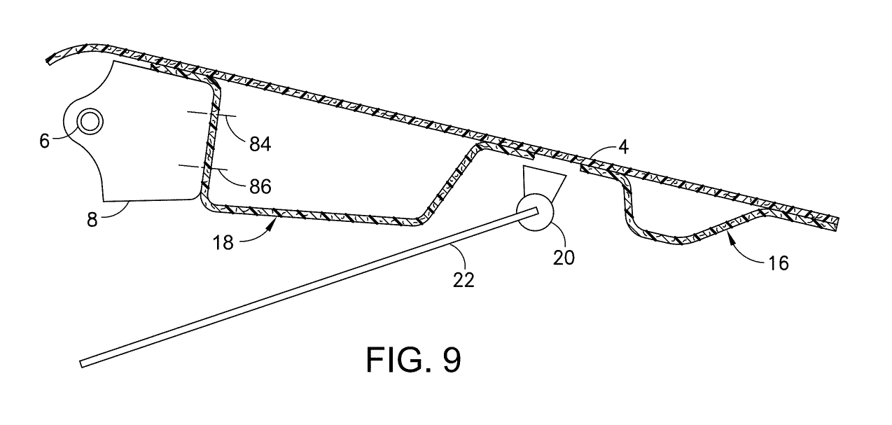

FIG. 9 is a diagram representing a sectional view of partially assembled components of a wing spoiler in accordance with an embodiment in which the base assembly has a configuration similar to the sixth configuration. In accordance with the sixth configuration of the base assembly shown in FIG. 8, the base skin 2 formed the lower surface of the flight control surface. In contrast, in accordance with the configuration of the base assembly shown in FIG. 9, the base skin 2 forms the upper surface of the wing spoiler.

Referring to FIG. 9, the base assembly comprises a base skin 2 made of laminated composite material. The base assembly further comprises a forward hat-shaped spar 18 and an aft hat-shaped spar 16, each made of laminated composite material and each having flanges integrally formed (i.e., co-infused) with base skin 2. The wing spoiler components depicted in FIG. 9 further include an actuator fitting 20 that will be attached to the base skin 4 and an actuator 22 (e.g., a hydraulic actuator) having a distal end that is rotatably coupled to the actuator fitting 20. The forward web of the forward hat-shaped spar 18 is attached to hinge fitting 8 by a pair of fasteners 84 and 86. The hinge fitting 8 is attached to an axle 6 that can be rotated in response to activation of the actuator 22, thereby causing the wing spoiler to rotate.

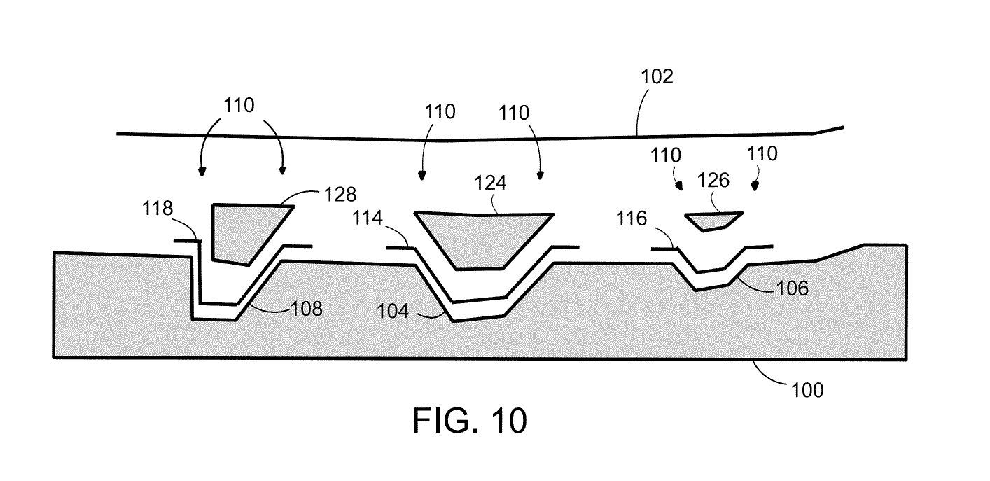

FIG. 10 is a diagram showing a tooling concept for manufacturing the base assembly depicted in FIG. 6 using a resin infusion process. The tooling comprises a base tool 100 having three concavities 104, 106 and 108 configured to mold composite material into respective hat-shaped spars. A plurality of plies of fabric 114 are laid on the surface of the base tool 100 such that major portions of those plies lie in the concavity 104. Then a mandrel 124 is placed in the concavity 104 on top of the plurality of plies of fabric 114. Another plurality of plies of fabric 116 are laid on the surface of the base tool 100 such that major portions of those plies lie in the concavity 106. Then a mandrel 126 is placed in the concavity 106 on top of the plurality of plies of fabric 116. A third plurality of plies of fabric 118 are laid on the surface of the base tool 100 such that major portions of those plies lie in the concavity 108. Then a mandrel 128 is placed in the concavity 108 on top of the plurality of plies of fabric 118. Noodles 110 are then placed adjacent to the portions of the fabric plies that will form the radiused sections connecting the flanges of the hat-shaped spars to the associated webs of the hat-shaped spars. Some applications may require the addition of one or more fabric plies to be wrapped around mandrels 124, 126 and 128 prior to these mandrels being placed in the cavities of the base tool 100 depicted in FIG. 10. Thereafter a plurality of plies of fabric 102 are overlaid on the base tool 100 and mandrels 124, 126 and 128. This plurality of plies of fabric 102 will become part of the base skin of the base assembly to be formed.

After the plurality of plies of fabric 102 have been laid down, a caul plate (not shown in FIG. 10) is placed over the plurality of plies of fabric 102. Preferably the caul plate has a surface that matches the desired outer surface of the base skin to be formed. A vacuum bag (not shown in FIG. 10) is then place over the caul plate. The periphery of the vacuum bag is sealed to the base tool 100 using sealing tape, thereby forming an evacuation chamber underneath the vacuum bag. The pressure inside the evacuation chamber is then reduced to a specified vacuum pressure. Resin is then infused into the pluralities of plies of fabric 102, 114, 116 and 118. The resin-infused fabric is then left to cure under vacuum pressure for a specified duration of time. After curing, the vacuum bag, caul plate and mandrels are removed (the mandrels may be of the dissolvable type). The final product will be a base assembly having hat-shaped spars whose flanges are co-infused with a base skin, such as the base assembly depicted in FIG. 6.

FIG. 11 is a diagram showing a tooling concept for manufacturing a base assembly having a structure similar to the base assembly depicted in FIG. 7 using a resin infusion process. The tooling comprises a base tool 100 having three concavities 106, 112 and 120. The concavity 106 is configured to mold composite material into a hat-shaped spar; the concavities 112 and 120 are configured to mold composite material into respective beam-shaped spars. A plurality of plies of fabric 116 are laid on the surface of the base tool 100 such that major portions of those plies lie in the concavity 106. Then a mandrel 126 is placed in the concavity 106. Another plurality of plies of fabric 138 are laid on the surface of the base tool 100 such that major portions of those plies lie in the concavity 112. In addition, a plurality of plies of fabric 134 are wrapped around three sides of a mandrel 122. Then the mandrel 122 and plurality of plies of fabric 134 are placed in the concavity 112 on top of the plurality of plies of fabric 138. Another plurality of plies of fabric 136 are laid on the surface of the base tool 100 such that major portions of those plies lie in the concavity 120. In addition, a plurality of plies of fabric 132 are wrapped around three sides of a mandrel 130. Then the mandrel 130 and plurality of plies of fabric 132 are placed in the concavity 120 on top of the plurality of plies of fabric 136. Noodles 110 are then placed adjacent to the portions of the fabric plies that will form the radiused sections connecting the flanges of the hat-shaped spar to the associated webs and adjacent to the portions of the fabric plies that will form the radiused sections connecting the flanges of the hat-shaped spars to the associated webs. Thereafter a plurality of plies of fabric 102 are overlaid on the base tool 100 and mandrels 122, 126 and 130. This plurality of plies of fabric 102 will become part of the base skin of the base assembly to be formed. Thereafter the processing steps previously described with reference to FIG. 10 are performed beginning with the placement of a caul plate over the plurality of plies of fabric 102. The final product will be a base assembly having one hat-shaped spar and two beam-shaped spars whose flanges are co-infused with a base skin, such as the base assembly depicted in FIG. 7.

In accordance with one embodiment, the method of manufacture comprises the following steps: placing a first plurality of plies of fabric on a surface of a base tool having a concavity configured to shape the hat-shaped spar; placing a mandrel in the concavity on top of the first plurality of plies of fabric; placing two noodles and a second plurality of plies of fabric over the mandrel and adjacent portions of the first plurality of plies of fabric; placing a caul plate over the second plurality of plies of fabric;

placing a vacuum bag over the caul plate; evacuating a space between the vacuum bag and the base tool; infusing resin into the first and second pluralities of plies of fabric; and curing the infused resin.

In accordance with one embodiment, the method of manufacture comprises the following steps: placing a multiplicity of braids on a surface of a base tool having a concavity configured to form the hat-shaped spar; placing a mandrel in the concavity on top of the multiplicity of braids in the concavity; placing two noodles and a multiplicity of tapes over the mandrel and adjacent portions of the multiplicity of braids; placing a caul plate over the multiplicity of tapes; placing a vacuum bag over the caul plate; evacuating a space between the vacuum bag and the base tool;

infusing resin into the multiplicity of braids and multiplicity of tapes; and curing the infused resin.

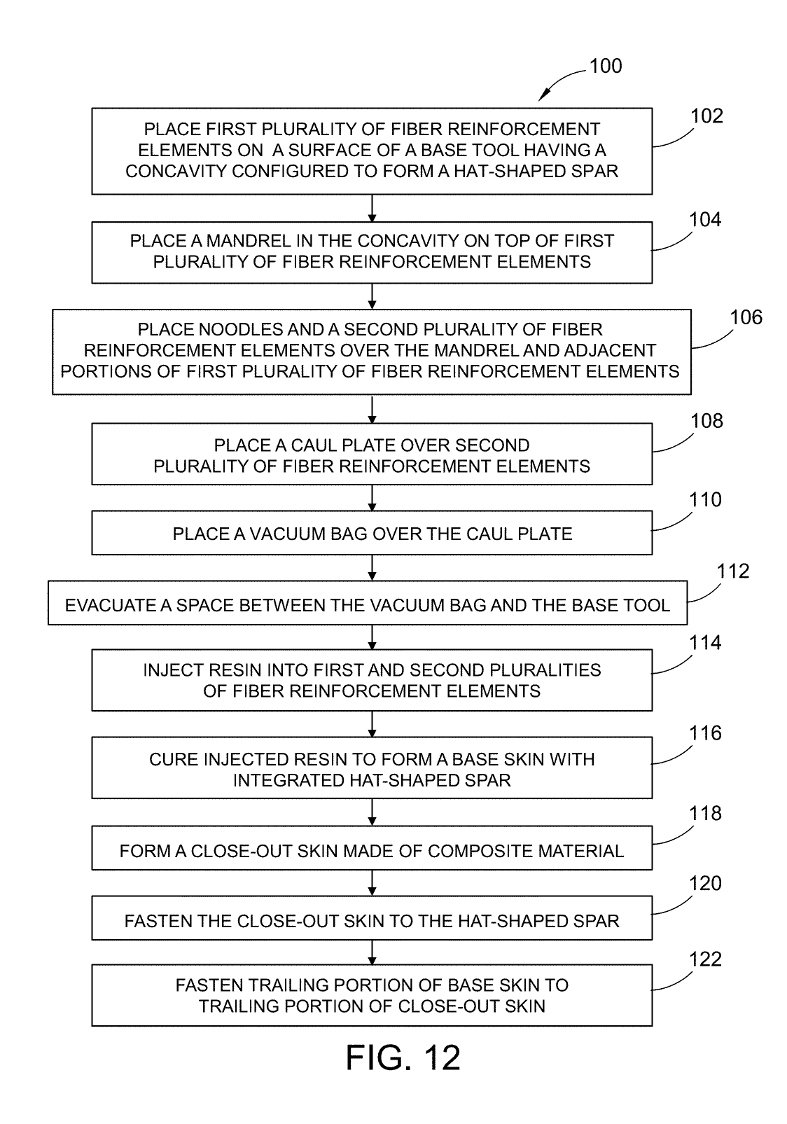

FIG. 12 is a flowchart identifying some steps of a method 100 for manufacturing an airfoil-shaped body having a hat-shaped spar with flanges co-infused with a base skin. A first plurality of fiber reinforcement elements (e.g., in the form of plies of fabric, tapes or braids) are laid on a surface of a base tool having a concavity configured to mold composite material into a hat-shaped spar (step 102). Then a mandrel is placed in the concavity on top of the first plurality of fiber reinforcement elements (step 104). Two noodles and a second plurality of fiber reinforcement elements are then laid over the mandrel and adjacent portions of the first plurality of fiber reinforcement elements (step 106). Next a caul plate is placed over the second plurality of fiber reinforcement elements (step 108). Then a vacuum bag is placed over the caul plate and sealed to the base tool (step 110). The space between the vacuum bag and the base tool is then evacuated (step 112). (As used herein, the term “to evacuate” means to reduce the pressure inside a space to a vacuum pressure greater than zero.) Resin is then injected into the first and second pluralities of fiber reinforcement elements (step 114). The injected resin is cured under vacuum pressure until a composite base skin with integrated hat-shaped spar is formed (step 116). In a separate process, a close-out skin made of composite material is formed (step 118). Then the close-out skin is fastened to the top of the hat-shaped spar (step 120). Then the trailing portion of the close-out skin is fastened to the trailing portion of the base skin to form a trailing edge of the airfoil-shaped body (step 122).

In cases where the airfoil-shaped body is a flap, the method described in the preceding paragraph would further comprise the step of fastening a D-shaped nose to the base and close-out skins.

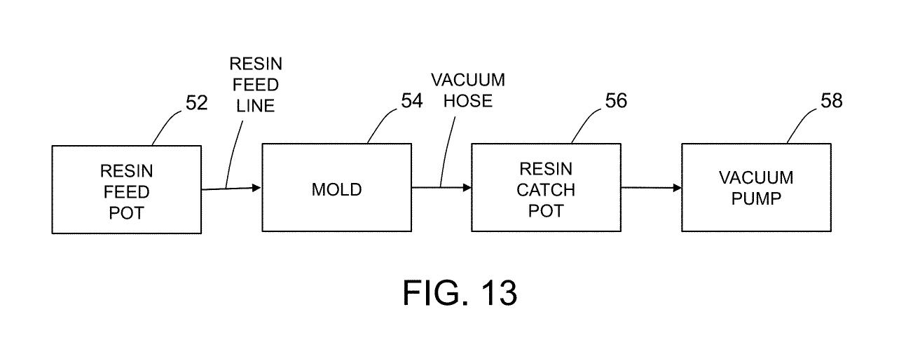

FIG. 13 is a block diagram identifying some components of a resin infusion system that can be used to manufacture base assemblies made of composite material. Resin infusion (a.k.a. vacuum resin infusion) is a technique for manufacturing high-performance, void-free composites (e.g., carbon fiber composites). In resin infusion, the reinforcement elements (e.g., plies of fabric, tapes or braids) are laid onto the base tool, e.g., mold 54 identified in FIG. 13, dry, i.e., without any resin, and then enclosed in bagging materials (such as peel ply, infusion mesh and bagging film) before being subjected to vacuum pressure using a vacuum pump, e.g., vacuum pump 58 identified in FIG. 13. After the air pressure inside the vacuum bag has been reduced to a level low enough to compress the reinforcement elements, liquid epoxy resin (mixed with hardener) is introduced into the reinforcement elements through a resin feed line, e.g., the resin feed line connecting the mold 54 to a resin feed pot as depicted in FIG. 13. This liquid epoxy resin then infuses through the reinforcement elements under the vacuum pressure. As depicted in FIG. 13, excess resin exits the mold 54 via a vacuum hose and is captured in a resin catch pot 56 that is in fluid communication with the vacuum hose and the vacuum pump 58. After the resin has fully infused through the reinforcement elements, the supply of resin is cut off and the resin is left to cure, still under vacuum pressure.

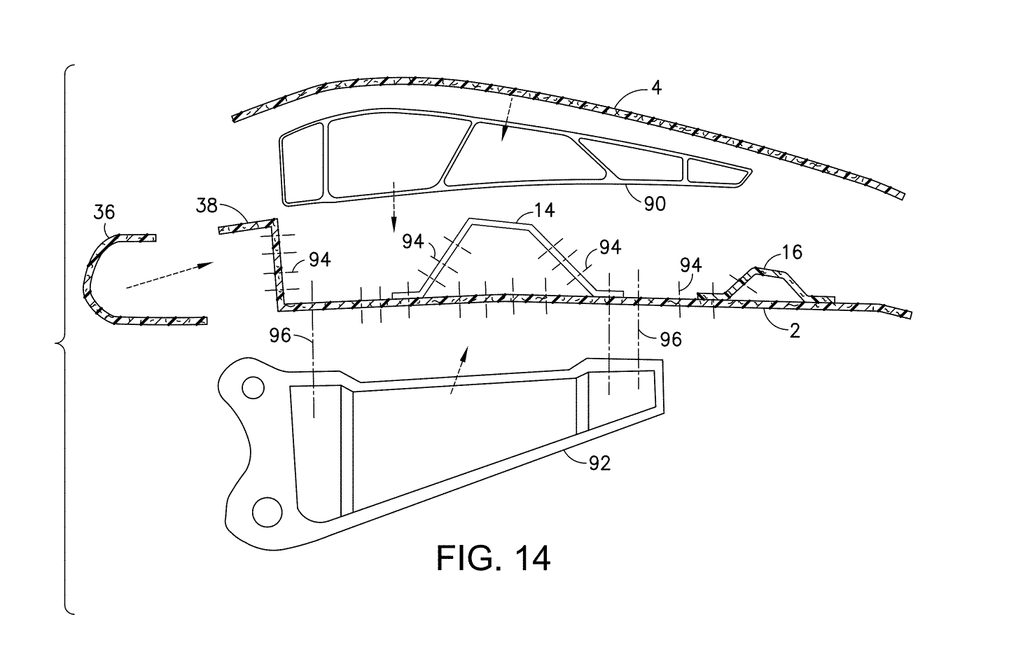

FIG. 14 is a diagram representing an exploded sectional view of unassembled components of a high-lift trailing edge flap of the type depicted in FIG. 4 having support fittings (viewed from one side) arranged in a first fitting configuration. This first fitting configuration comprises a one-piece internal fitting 90 (which will be disposed between the base skin 2 and the close-out skin 4 in the final assembly) that extends from the web of the forward inverted L-shaped spar 38 to the forward web of the aft hat-shaped spar 16. The internal fitting 90 passes through a vertical slot formed in the webs and top of the intermediate hat-shaped spar 14 (the presence of a slot being indicated by the absence of hatching in the sectional view). Fasteners 94 for attaching flanges of the internal fitting 90 to the base assembly are indicated by dash-dot lines. The first fitting configuration further comprises a hinge fitting 92 which is coupled to an actuator (not shown). Fasteners 96 for attaching the internal fitting 90 to the hinge fitting 92 are also indicated by dash-dot lines. The fully assembled flap will rotate in tandem with the hinge fitting 92. Typically the flap incorporates at least two fitting arrangements of the type depicted in FIG. 14.

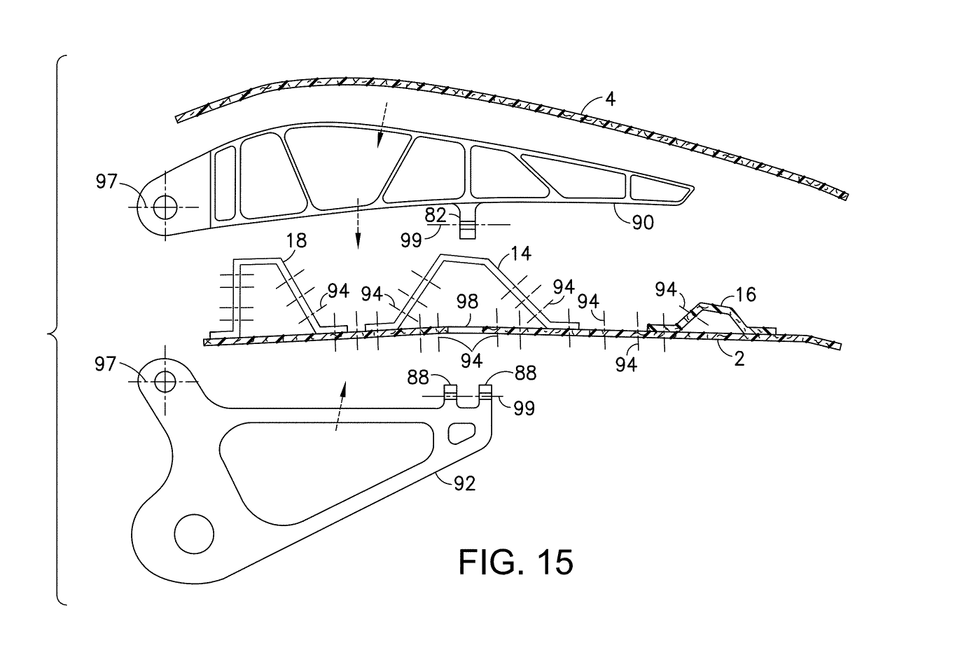

FIG. 15 is a diagram representing an exploded sectional view of unassembled components (not including nose 36) of a high-lift trailing edge flap of the type depicted in FIG. 6 having support fittings (viewed from one side) arranged in a second fitting configuration. This second fitting configuration comprises a one-piece internal fitting 90 that extends from the web of the forward hat-shaped spar 18 to the forward web of the aft hat-shaped spar 16. The internal fitting 90 passes through a vertical slot formed in the forward and aft webs and top of the intermediate hat-shaped spar 14 and through a vertical slot formed in the aft web and top of the forward hat-shaped spar 18 (the presence of those slots being indicated by the absence of hatching in the sectional view). Fasteners 94 for attaching flanges of the internal fitting 90 to the base assembly are indicated by dash-dot lines. The second fitting configuration further comprises a hinge fitting 92 which is coupled to an actuator (not shown). At two locations, large-diameter bolts 97 and 99 (indicated by dash-dot lines) are used to attach the internal fitting 90 to the hinge fitting 92. For example, as seen in FIG. 15, a lug 82 of the internal fitting 90 is passed through an opening 98 in the base skin 2 and coupled to a clevis joint 88 of the hinge fitting 92 by means of bolt 99. The fully assembled flap will rotate in tandem with the hinge fitting 90. Typically the flap incorporates at least two fitting arrangements of the type depicted in FIG. 15.

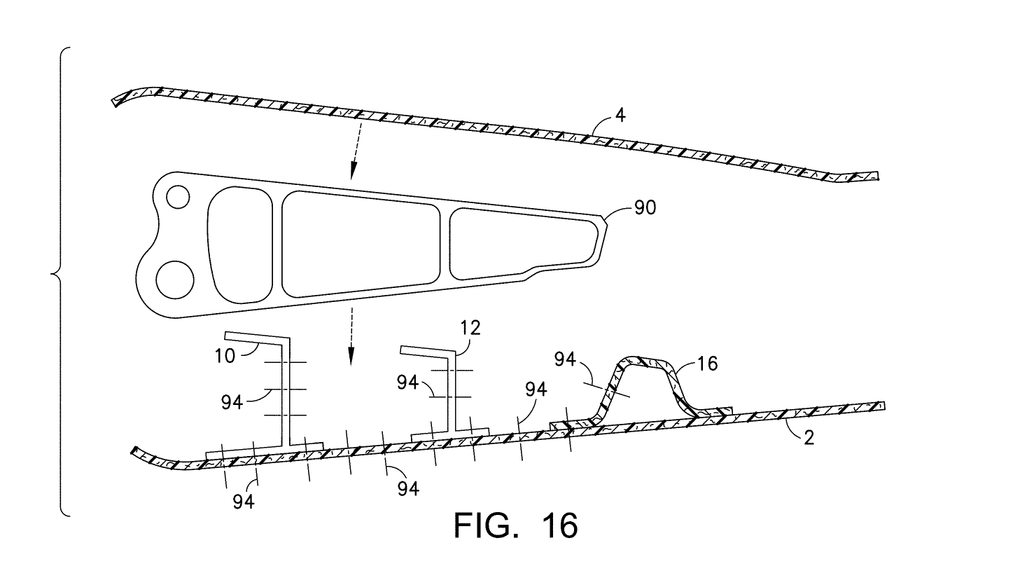

FIG. 16 is a diagram representing an exploded sectional view of unassembled components of a flight control surface of the type depicted in FIG. 7 having support fittings (viewed from one side) arranged in a third fitting configuration. This third fitting configuration comprises a one-piece internal fitting 90 that extends from the web of the forward beam-shaped spar 10 to the forward web of the aft hat-shaped spar 16. The internal fitting 90 passes through a vertical slot formed in the web and top of the intermediate beam-shaped spar 12 and through a vertical slot formed in the web and top of the forward beam-shaped spar 10 (the presence of those slots being indicated by the absence of hatching in the sectional view). Fasteners 94 for attaching the internal fitting 90 to the base assembly are indicated by dash-dot lines. Typically the flight control surface incorporates at least two fitting arrangements of the type depicted in FIG. 16.

In embodiments having multiple integrated hat-shaped spars, the hat-shaped spars may have irregular base angles, allowing tailoring of the section to integrate with load introduction fittings and component loft requirements. The hat-shaped spars can have cross-sectional shape tailoring in the spanwise direction and the section thickness can be tailored in the spanwise and chordwise directions dependent on structural requirements.

The embodiments depicted in FIGS. 3 through 9 provide: (a) reduced manufacturing cost through reduced detail part and fastener count compared to current practice; (b) simpler tooling; (c) greater access for easier non-destructive inspection; (d) better fitting integration; and (e) simpler repair options compared to current practice. The simple tooling concepts depicted in FIGS. 10 and 11 provide tooled spar interfaces to minimize assembly shim.

Furthermore, each embodiment depicted in FIGS. 3 through 9 has a main load loop “bathtub” featuring spanwise spar stiffening. When combined with the close-out skin, the assembly is highly efficient in reacting spanwise bending and torsion, which are the main loading modes for a trailing edge flap or flight control surface. Due to this structural efficiency, significantly fewer chordwise ribs are required compared to designs with stringer stiffened skins.

The main load loop “bathtub” can be co-cured in a single piece, which reduces the number of fasteners required in the component assembly. Less fastening (and associated weight driving fastened joint design requirements) allows greater structural efficiency to be gained from the whole component. Co-curing the “bathtub” produces bonded joints with enhanced structural properties compared to co-bonded or secondary bonded joints.

The multi-spar designs depicted in FIGS. 3-9 provide redundancy for the co-cured joints to enable the design to be damage tolerant for any single failure of a continuous co-cured joint, assuming a complete bond failure between arrestment features.

In addition, the embodiments depicted in FIGS. 3-9 feature a small hat-shaped spar close to the trailing edge skin close-out. This small hat-shaped trailing edge close-out spar is integrated into the base skin and hence can be placed in close proximity to the trailing edge skin close-out joint. This aft spar location maximizes the size of the main load loop and also reduces the trailing edge close-out joint loads, which helps simplify the design of this secondary structure close-out. The enclosed cross section of the close-out (i.e., aft) hat-shaped spar provides good torsional stiffness, which is beneficial in reducing loads and deflections at the flexible trailing edge close-out joint. The trailing edge skin close-out joint can be designed reliably with simple double flush rivets because the joint is outside the main load loop.

The hat-shaped spars integrated with the base skin in the embodiments depicted in FIGS. 4-6 and 8 provide multiple bonded joints which stabilize the base skin and allow for a minimum weight skin. The close-out skin is a relatively simple curved detail part which can be fabricated from CFRP solid laminate, honeycomb panelized pre-preg or stamped thermoplastic, with selection based on the minimum cost/weight solution.

While airfoil-shaped bodies having hat-shaped spars and methods for manufacturing such airfoil-shaped bodies have been described with reference to various embodiments, it will be understood by those skilled in the art that various changes may be made and equivalents may be substituted for elements thereof without departing from the teachings herein. In addition, many modifications may be made to adapt the concepts and reductions to practice disclosed herein to a particular situation. Accordingly, it is intended that the subject matter covered by the claims not be limited to the disclosed embodiments.

The method claims set forth hereinafter should not be construed to require that the steps recited therein be performed in alphabetical order (any alphabetical ordering in the claims is used solely to facilitate the referencing of previously recited steps) or in the order in which they are recited. For example, a base assembly and a close-out skin may be formed in sequence or concurrently or the respective forming processes may be partially overlapping in time. In cases of sequential formation, one of the base assembly and close-out skin can be formed before the other.

1. An airfoil-shaped body comprising:
a base skin made of composite material;
a first hat-shaped spar made of composite material and comprising a forward flange and an aft flange integrally formed with the base skin, a top, a forward web that connects the forward flange to the top, and an aft web that connects the aft flange to the top;
a close-out skin; and
a first plurality of fasteners by which the close-out skin is attached to the top of the first hat-shaped spar.

2. The airfoil-shaped body as recited in claim 1, wherein a profile of the first hat-shaped spar varies in a spanwise direction.

3. The airfoil-shaped body as recited in claim 1, wherein a thickness of the forward web of the first hat-shaped spar varies in a spanwise direction.

4. The airfoil-shaped body as recited in claim 1, wherein the top of the first hat-shaped spar is not parallel to the base skin.

5. The airfoil-shaped body as recited in claim 1, wherein a first base angle between the forward web of the first hat-shaped spar and the base skin is different than of a second base angle between the aft web of the first hat-shaped spar and the base skin.

6. The airfoil-shaped body as recited in claim 1, further comprising:
a second hat-shaped spar made of composite material and comprising a forward flange and an aft flange integrally formed with the base skin, a top, a forward web that connects the forward flange to the top, and an aft web that connects the aft flange to the top; and
a second plurality of fasteners by which the close-out skin is attached to the top of the second hat-shaped spar.

7. The airfoil-shaped body as recited in claim 6, further comprising a nose and a third plurality of fasteners by which the nose is attached to the base skin.

8. The airfoil-shaped body as recited in claim 6, further comprising a hinge fitting, an internal fitting attached to the hinge fitting, a third plurality of fasteners by which the second hat-shaped spar is attached to the internal fitting, and a fourth plurality of fasteners by which the close-out skin is attached to the internal fitting.

9. The airfoil-shaped body as recited in claim 1, wherein the close-out skin comprises a first laminate made of composite material.

10. The airfoil-shaped body as recited in claim 9, wherein the close-out skin further comprises:
a first honeycomb panel made of composite material and integrated with the first laminate; and
a second laminate made of composite material and integrated with the first honeycomb panel,
wherein the first honeycomb panel overlies a first space between the first and second hat-shaped spars.

11. The airfoil-shaped body as recited in claim 10, further comprising a third plurality of fasteners by which a trailing portion of the close-out skin is attached to a trailing portion of the base skin to form a trailing edge of the airfoil-shaped body, wherein the close-out skin further comprises:
a second honeycomb panel made of composite material and integrated with the first laminate; and
a third laminate made of composite material and integrated with the second honeycomb panel,
wherein the second honeycomb panel overlies a second space between the first hat-shaped spar and the trailing edge.

12. The airfoil-shaped body as recited in claim 1, further comprising:
a hinge fitting;
an internal fitting attached to the hinge fitting;
a forward spar made of composite material and comprising a forward flange and an aft flange integrally formed with the base skin; and
a second plurality of fasteners by which the forward spar is attached to the internal fitting.

13. An airfoil-shaped body comprising:
a base skin made of composite material;
a first hat-shaped spar made of composite material and comprising a forward flange and an aft flange integrally formed with the base skin, a top, a forward web that connects the forward flange to one side of the top, and an aft web that connects the aft flange to another side of the top;
a close-out skin;
a first plurality of fasteners by which the close-out skin is attached to the top of the first hat-shaped spar; and
a second plurality of fasteners by which a trailing portion of the close-out skin is attached to a trailing portion of the base skin to form a trailing edge of the airfoil-shaped body.

14. The airfoil-shaped body as recited in claim 13, wherein a profile of the first hat-shaped spar varies in a spanwise direction.

15. The airfoil-shaped body as recited in claim 13, wherein a thickness of the forward web of the first hat-shaped spar varies in a spanwise direction.

16. The airfoil-shaped body as recited in claim 13, wherein the top of the first hat-shaped spar is not parallel to the base skin.

17. The airfoil-shaped body as recited in claim 13, wherein a first base angle between the forward web of the first hat-shaped spar and the base skin is different than of a second base angle between the aft web of the first hat-shaped spar and the base skin.

18. The airfoil-shaped body as recited in claim 13, further comprising:
a second hat-shaped spar made of composite material and comprising a forward flange and an aft flange integrally formed with the base skin, a top, a forward web that connects the forward flange to one side of the top, and an aft web that connects the aft flange to another side of the top; and
a third plurality of fasteners by which the close-out skin is attached to the top of the second hat-shaped spar.

19. The airfoil-shaped body as recited in claim 13, further comprising a nose and a third plurality of fasteners by which the nose is attached to the base skin.

20. A method of manufacturing an airfoil-shaped body, comprising:
(a) forming a base assembly made of composite material using a resin infusion process, the base assembly comprising a base skin and a hat-shaped spar having a forward flange and an aft flange integrally formed with the base skin, a top, a forward web that connects the forward flange to the top, and an aft web that connects the aft flange to the top;
(b) forming a close-out skin;
(c) fastening the close-out skin to the top of the hat-shaped spar; and
(d) fastening a trailing portion of the base skin to a trailing portion of the close-out skin.

21. The method as recited in claim 20, wherein step (a) comprises:
placing a first plurality of plies of fabric on a surface of a base tool having a concavity configured to shape the hat-shaped spar;
placing a mandrel in the concavity on top of the first plurality of plies of fabric;
placing two noodles and a second plurality of plies of fabric over the mandrel and adjacent portions of the first plurality of plies of fabric;
placing a caul plate over the second plurality of plies of fabric;
placing a vacuum bag over the caul plate;
evacuating a space between the vacuum bag and the base tool;
infusing resin into the first and second pluralities of plies of fabric; and
curing the infused resin.

22. The method as recited in claim 20, wherein step (a) comprises:
placing a multiplicity of braids on a surface of a base tool having a concavity configured to form the hat-shaped spar;
placing a mandrel in the concavity on top of the multiplicity of braids in the concavity;
placing two noodles and a multiplicity of tapes over the mandrel and adjacent portions of the multiplicity of braids;
placing a caul plate over the multiplicity of tapes;
placing a vacuum bag over the caul plate;
evacuating a space between the vacuum bag and the base tool;
infusing resin into the multiplicity of braids and multiplicity of tapes; and
curing the infused resin.
